(19) United States
(12) Patent Application Publication
(10) Pub. No.: US 2011/0297408 A1
(43) Pub. Date: Dec. 8, 2011

(54) DRIVE FOR A ROD-SHAPED MACHINE ELEMENT

(76) Inventor: Georg Bründermann, Thuine (DE)

(21) Appl. No.: 13/201,490

(22) PCT Filed: Feb. 15, 2010
(86) PCT No.: PCT/EP10/51837

§ 371 Date: Aug. 15, 2011

(30) Foreign Application Priority Data
Feb. 17, 2009 (DE) 10 2009 009 205.6

(51) Int. Cl. B23Q 5/00

(52) U.S. Cl. 173/147

(57) ABSTRACT

A drive for a machine element having an elongated shape including an elongated, flexible traction element (2; 29) helically guided around the machine element (1) in several turns (3), the traction element (2; 29) being drivable in both directions.

### CROSS-REFERENCE TO RELATED APPLICATIONS

This application is a Section 371 of International Application No. PCT/EP2010/051837, filed Feb. 15, 2010, which was published in the German language on Aug. 26, 2010, under

International Publication No. WO 2010/094642 A2, and the disclosure of which is incorporated herein by reference.

### BACKGROUND OF THE INVENTION

The present invention relates generally to a drive for a rod-shaped machine element, and, in particular, for a blower pipe of a soot blower that is moved axially forward and backward and simultaneously set in rotation.

On conventional soot blowers, which serve to clean the heat transfer devices of large boilers that are in operation, a stationary line pipe is provided, which is connected to a likewise stationary steam or water connection. Typically guided on the stationary line pipe is an outer pipe, which is guided on the inner pipe in axially sliding fashion and can be inserted into the boiler through an opening. Typically provided in the end area of a sliding outer pipe of this kind are outlet nozzles, distributed around the circumference, from which the steam or water emerges under high pressure and removes the soot from the internal equipment, particularly the heat transfer devices. The outer pipe rotating during operation is set in rotation via gearwheels or ladder chains. At the same time, there is also axial movement, by means of which the outer pipe can be advanced into the boiler and retracted from it again. Rack-and-pinion drives, for example, serve as the axial drive. A drive mechanism of this kind is extremely complex and, moreover, susceptible to faults.

A flexible steam or water supply system in the form of articulated pipes has already been proposed (DE 10 2008 036 686.2), thus making it possible to dispense with a separate, high-grade steel inner pipe and design the line pipe connected to the water connection as the blower pipe. The blower pipe can then be moved in the axial direction on a carriage and thus advanced into the boiler and retracted from it again. In addition, a rotational drive for the blower pipe is necessary. Even a design of this kind requires two drives, for example, the carriage drive for longitudinal movement of the blower pipe, on the one hand, and the drive for generating rotary movement of the blower pipe, on the other.

### BRIEF SUMMARY OF THE INVENTION

An objective of a preferred embodiment of the present invention is to greatly simplify the drive for a rod-shaped machine element, and, in particular, for a the blower pipe of a soot blower that has to be moved axially forward and backward and simultaneously set in rotation.

According to a preferred embodiment of the present invention, the above objective is solved in that an elongated, flexible traction element is provided, in that the traction element is helically guided around the rod-shaped machine element or the blower pipe of a soot blower in several turns, and in that the traction element is drivable in both directions.

If, given a design of this kind, the traction element is moved in the one direction, it correspondingly carries along the machine element to be driven, setting it in rotation. If the traction element is moved in the other direction, the direction of rotation is reversed. Due to the fact that the traction element is guided around the machine element not only in the circumferential direction, but also in several helical turns, axial movement is also generated when the traction element moves, in either the one or the other axial direction, depending on the driving direction of the traction element.

A wire cable can be used as the traction element for various applications, since it is sufficiently flexible and, moreover, capable of transmitting relatively high forces.

If the traction element is to be used to drive the blower pipe of a soot blower, it is preferably designed as a link chain. A link chain of this kind expediently consists of steel links, where these can be of roughly oval and closed design, interlocking at an angle of 90° relative to each other.

In a preferred embodiment of the present invention, the traction element is of endless design. The endless traction element can then be driven by means of a rotating drum, around which the traction element is at least partly wrapped. Alternatively, the traction element can also be of open-ended design, where the ends of the traction element can optionally be moved in either the one or the other direction of traction, depending on the required direction of travel of the rod-shaped machine element.

To drive the traction element, each of its two ends can be designed to be wound up on a separate, drivable drum. Alternatively, the ends of the open-ended traction element can also be wound up in opposite directions on a common drum, where the drum can be driven in both directions of rotation.

To be able to vary the travel speed of the machine element or blower pipe at a constant drum rpm speed, the angle of rise of the turns of the traction element on the rod-shaped machine element or blower pipe can be variable. This is preferably achieved by the distance between the take-up area and the pay-out area of the traction element being variable. A design of this kind makes it very easy to vary the angle of rise of the turns, this enabling continuously variable control of the travel speed of the machine element or blower pipe, or also control in steps.

To vary the distance between the take-up area and the pay-out area of the traction element, the latter can be guided around a deflection pulley, where the axis of the deflection pulley can be moved, at least in one component, in the longitudinal direction of the machine element or blower pipe to be driven. In this context, the deflection pulley can be mounted on an arm that can be displaced roughly parallel to the axis of rotation of the rod-shaped machine element or blower pipe.

To stabilize the traction element, and to compensate for the change in length when varying the angle of rise of the traction element on the rod-shaped machine element, the traction element can be guided around at least one compensating pulley, where the compensating pulley rests on the traction element under spring pressure.

### BRIEF DESCRIPTION OF THE SEVERAL VIEWS OF THE DRAWINGS

The foregoing summary, as well as the following detailed description of the present invention, will be better understood when read in conjunction with the appended drawings. For the purpose of illustrating the present invention, there are shown in the drawings embodiments which are presently preferred. It should be understood, however, that the invention is not limited to the precise arrangements and instrumentalities shown. In the drawings:

FIG. 1 is a side view of a drive for a blower pipe of a soot blower, with an endless link chain, in accordance with a preferred embodiment of the present invention;

FIG. 2 is the same view of the drive according to FIG. 1, with an enlarged angle of rise of the link chain on the blower pipe;

FIG. 3 is a view of a larger section of the blower pipe, including its guide;

FIG. 4 is a view in the direction of arrow IV in FIG. 3;

FIG. 5 is a different practical example of a drive for the blower pipe of a soot blower, with a wire cable of open-ended design, in accordance with another preferred embodiment of the present invention; and

FIG. 6 is a side view of the drive according to FIG. 5 in the direction of arrow VI.

### DETAILED DESCRIPTION OF THE INVENTION

Certain terminology is used in the following description for convenience only and is not limiting. The words “right” and “left” designate directions in the drawings to which reference is made. Unless specifically set forth herein, the terms “a,” “an” and “the” are not limited to one element, but instead should be read as meaning “at least one.” The terminology includes the words noted above, derivatives thereof and words of similar import.

FIG. 1 shows a drive of a blower pipe 1 for a soot blower in accordance with a preferred embodiment of the present invention. The blower pipe 1, only a short section of which is shown, is preferably mounted in axially sliding and rotating fashion.

A common drive serves to drive the blower pipe 1 in its longitudinal direction and to simultaneously rotate the blower pipe 1. The drive essentially consists of an endless link chain 2 or round steel chain that is helically guided around the blower pipe 1 in several turns 3. The link chain 2 preferably consists of closed steel links, not illustrated in more detail in the drawing, that interlock at an angle of 90° relative to each other, such as described in DIN 22252 (round steel chains) or DIN 763, DIN 764 or DIN 766.

Roughly half a turn or a partial contact area 4 of the link chain 2 runs around a drum 5, which can optionally be driven in both directions by means of an electric motor 6 and a gearbox 7 that is only illustrated schematically in the drawings. The drum 5 is designed as a toothed chain wheel.

As a result of the movement of the endless link chain 2, the blower pipe 1 is not only set in rotation, but also displaced in the axial direction due to the angle of rise of the turns 3. Depending on the running direction of the link chain 2, the blower pipe 1 is moved to the right or the left in the drawings. If, for example, the drum 5 rotates counter-clockwise, in the direction of arrow 8, causing the link chain 2 to move in a direction corresponding to arrow 9, the blower tube 1 is moved towards the right in the drawings, being moved to the left if the direction of rotation of the drum 5 is reversed.

If the rpm speed of the drum 5 is constant, the travel speed of the blower pipe 1 is likewise constant, where the travel speed is dependent on the angle of rise of the turns 3 of the link chain 2 on the blower pipe 1. Varying the angle of rise of the turns 3 makes it very easy to vary the travel speed of the blower pipe 1, either continuously or also in steps.

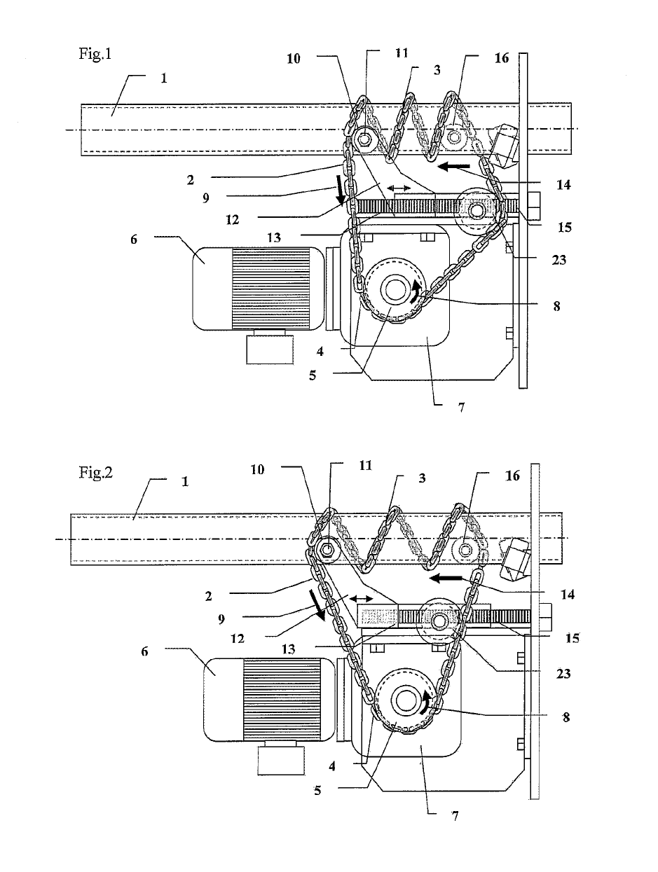

In the practical example illustrated in FIGS. 1 and 2, the angle of rise of the turns 3 can be varied very easily by guiding the link chain 2 around a guide pulley 10, whose axis 11 lying transversely to the blower pipe 1 can be moved in the longitudinal direction of the blower pipe 1, at least with one component. Movement of the axis 11 of the guide pulley 10 can, for example, be accomplished by the guide pulley 10 being mounted on an arm 12 that can be displaced along a guide 13 running parallel to the blower pipe 1. So, if the arm 12 is moved out of the position shown in FIG. 1 in the direction of the arrow 14, the guide pulley 10 moves to the left on a path parallel to the longitudinal axis of the blower pipe 1, as a result of which the turns 3 of the link chain 2 are drawn apart, meaning that the angle of rise of the turns 3 becomes greater. If the drum rpm speed remains constant, the travel speed of the blower pipe 1 likewise becomes greater as a result. If the arm 12 is moved in the opposite direction, the angle of rise of the turns 3 becomes smaller, and the travel speed of the blower pipe 1 thus also becomes smaller. Provided on the opposite side of the blower pipe 1 is a second guide pulley 10 that stabilizes the take-up and pay-out area of the link chain 2 relative to the blower pipe 1.

The Arm 12 is moved by means of a rack-and-pinion drive 15, which is secured in pivoting fashion on a stationary frame 17. The frame 17 simultaneously also bears the gearbox 7 and the electric motor 6.

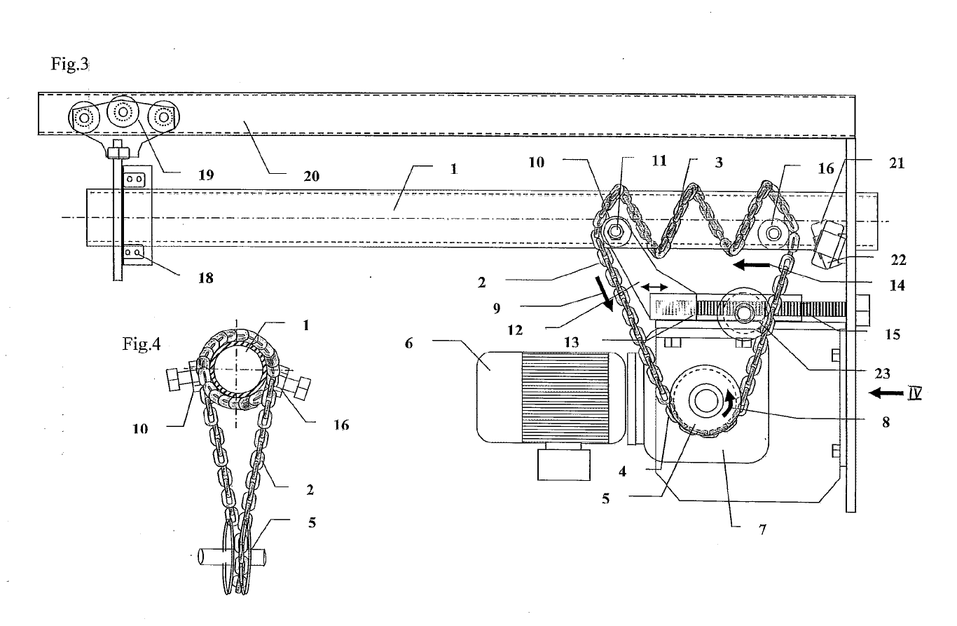

FIGS. 3 and 4 show the mounting of the blower pipe 1 in detail. At its left-hand end, the blower pipe 1 sits in a bearing 18, in which the blower pipe 1 is mounted in rotating fashion. The bearing 18 is fixed in place relative to the blower pipe 1 in the axial direction on the blower pipe 1, and can be moved together with the blower pipe 1 in the axial direction of the latter. The bearing 18 is suspended from a travelling crab 19 that is guided on a rail 20 running parallel to the blower pipe 1.

The right-hand side of the blower pipe 1 in the drawing is guided on two supporting rollers 21 and 22, which are shown in detail in FIGS. 3 and 4.

To keep the endless link chain 2 consistently taut in all positions of the arm 12, a compensating pulley 23 is provided, which is pressed against the link chain 2 by means of a spring 24 and likewise moves to the left when the arm 12 moves to the left, for example, in order to compensate for the change in length caused by the change in the angle of rise.

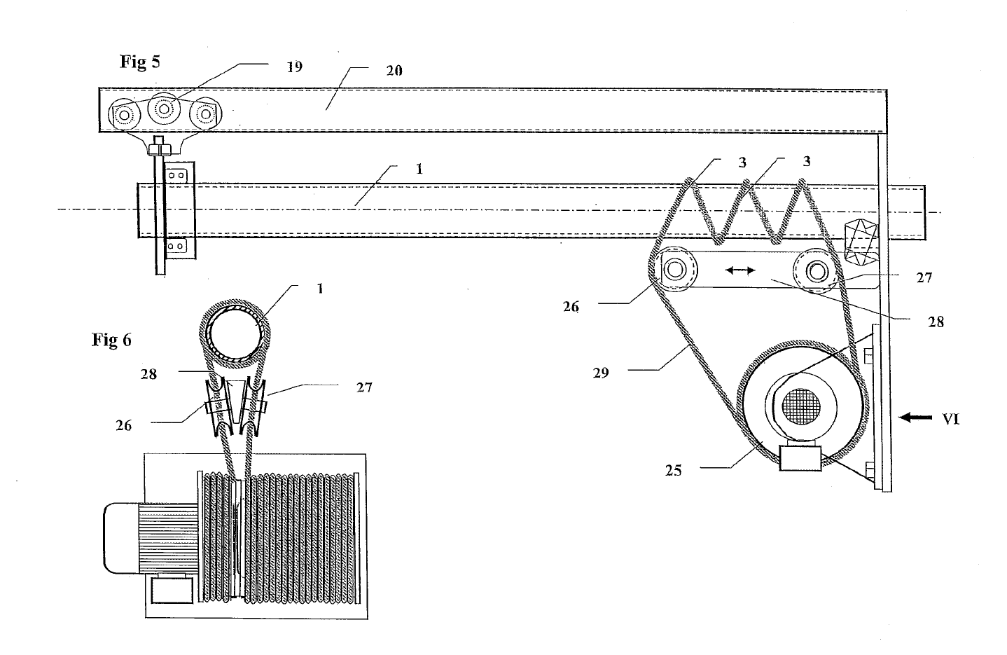

FIGS. 5 and 6 illustrate a different practical example of the drive for the blower pipe 1. Since many features of the design are very similar to the practical example according to FIGS. 1-4, the same item numbers are used for similar machine parts.

The essential difference between the two preferred embodiments is that the traction element, such as a wire cable 29, used to drive the blower pipe 1 is of open-ended design. The two ends of the wire cable 29 are wound up in opposite directions on a common drum 25, and the drum 25 can be driven in both directions of rotation, just as in the practical example illustrated in FIGS. 1-4. So, if the drum 25 rotates in the one direction, the one end of the wire cable 29 is taken up, while the other end is paid out. The wire cable 29 is moved as a result, carrying along the blower pipe 1 in both the direction of rotation and the axial direction owing to its turns 3, which run around the blower pipe 1 several times. Depending on the direction of rotation of the drum 25, the blower pipe 1 rotates in the clockwise or counter-clockwise direction and is moved in the one or the other axial direction.

In the practical example illustrated in FIGS. 5 and 6, too, the angle of rise of the turns 3, which extend around the blower pipe 1, is variable. A guide pulley 26, guided on a rail 28, is provided to this end. Also located on the same rail 28 is a compensating pulley 27, which is secured on guide rail 28 in a manner permitting displacement against the pressure of a spring not shown in the drawings. The distance between the two pulleys 26 and 27 is variable. In the position of the pulleys 26 and 27 shown in FIG. 5, the angle of rise of the turns 3 of the wire cable 29 on the blower pipe 1 is relatively large. If, for example, the guide pulley 26 moves along the guide rail 28 in the direction of the compensating pulley 27, and the distance between the two pulleys becomes smaller, the angle of rise of the turns 3 likewise becomes smaller and the travel speed of the blower pipe 1 in the axial direction is continuously reduced if the drum rpm speed remains constant.

As in the practical example illustrated in FIGS. 1-4, a link chain can also be used as the traction element in the practical example illustrated in FIGS. 5 and 6, instead of the wire cable 29.

The drive according to a preferred embodiment of the present invention, illustrated on the basis of the blower pipe of a soot blower, can be used for all rod-shaped machine elements that have to be moved simultaneously in the axial direction and the direction of rotation. According to a preferred embodiment of the present invention, this is accomplished by means of the flexible traction element, preferably a link chain or a wire cable, which is guided in several turns around the rod-shaped machine element to be driven. The relatively easily accomplished change in the angle of rise of the turns of the traction element on the rod-shaped machine element permits very convenient adjustment of the travel speed of the rod-shaped machine element.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-14. (canceled)

15. A drive for a machine element having an elongated shape, the drive comprising an elongated, flexible traction element (2; 29) helically guided around the machine element (1) in several turns (3), the traction element (2; 29) being drivable in both directions.

16. The drive according to claim 15 wherein the traction element is a wire cable.

17. The drive according to claim 15 wherein the traction element is a link chain (2; 29).

18. The drive according to claim 17, wherein the link chain (2; 29) consists of closed steel links of roughly oval design that interlock at an angle of 90° relative to each other.

19. The drive according to claims 15, wherein the traction element (2) is of endless design.

20. The drive according to claim 17, wherein the traction element (2; 29) is drivable by means of a rotating drum (5; 25), the traction element (2; 29) being at least partly wrapped around the rotating drum.

21. The drive according to claim 15, wherein the traction element (29) is of open-ended design, ends of the traction element (29) are movable in either one or another direction of traction, depending on the required direction of travel of the machine element (1).

22. The drive according to claim 21, wherein each of the ends of the open-ended traction element (29) is wound up on a separate, drivable drum.

23. The drive according to claim 21, wherein the ends of the open-ended traction element (29) are wound up on a common drum (25) drivable in both directions of rotation.

24. The drive according to claim 15, wherein an angle of rise of the turns (3) of the traction element (2; 29) on the machine element (1) is variable.

25. The drive according to claim 24, wherein a distance between a take-up area and a pay-out area of the traction element (2; 29) is variable.

26. The drive according to claim 24, wherein the traction element (2; 29) is guided around at least one guide pulley (10; 26), and an axis (11) of the guide pulley (10; 26) is movable in a longitudinal direction of the machine element (1) to be driven, at least with one component.

27. The drive according to claim 26, wherein the at least one guide pulley (10) is mounted on an arm (12) displaceable roughly parallel to an axis of rotation of the machine element.

28. The drive according to claim 15, wherein the traction element (2; 29) is guided around at least one compensating pulley (23; 27) that rests against the traction element (2; 29) under spring pressure.

29. The drive according to claim 15, wherein the machine element is a blower pipe of a soot blower that is moved axially forward and backward and simultaneously set in rotation.
